(19) United States
(12) Patent Application Publication
(10) Pub. No.: US 2008/0279371 A1
(43) Pub. Date: Nov. 13, 2008

(54) METHODS OF ENCRYPTING AND DECRYPTING DATA AND BUS SYSTEM USING THE METHODS

(75) Inventors: Hyung-jick LEE, Seongnam-si (KR); Jae-min Lee, Suwon-si (KR); Jun-bum Shin, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/025,829

(22) Filed: Feb. 5, 2008

(30) Foreign Application Priority Data
May 8, 2007 (KR) 10-2007-0044699

(51) Int. Cl. H04L 9/00

(52) U.S. Cl. 380/42

(57) ABSTRACT

Methods of encrypting and decrypting data, and a bus system using the methods are provided. The method of encrypting data includes: performing an operation on data that is to be transmitted through a bus with a key stream generated from a predetermined key so as to encrypt the data; transmitting the encrypted data to a predetermined module through the bus; and transmitting a synchronization signal that is logic high when the encrypted data is transmitted through the bus to the predetermined module. Therefore, an encryption speed is improved and encryption can be simply embodied so that security of data received from the bus can be improved.

### CROSS-REFERENCE TO RELATED PATENT APPLICATION

This application claims priority from Korean Patent Application No. 10-2007-0044699, filed on May 8, 2007, in the Korean Intellectual Property Office, the disclosure of which is incorporated herein in its entirety by reference.

### BACKGROUND OF THE INVENTION

1. Field of the Invention

Methods and bus systems consistent with the present invention relate to encrypting and decrypting data.

2. Description of the Related Art

Encryption systems can be classified into public key encryption systems and private key encryption systems according to a method of operating a key. In a public key encryption system, all users have public keys available to the public and private keys or secret keys of their own. The public keys are used to encrypt documents and the private key, and the private keys are used to decrypt encrypted documents while an individual stores the documents. On the other hand, in a private key encryption system, encryption and decryption (decoding) are performed at the same time. Private key encryption systems can be classified into block cipher systems and stream cipher systems.

The block cipher system divides a given plain text into blocks having fixed lengths (64 bit or 128 bit) to perform an encryption in block units. The stream cipher system performs an exclusive OR (XOR) operation on a key stream induced from a secret key and a plain text to generate an encryption text, instead of dividing a plain text into blocks. In general, the stream cipher system is faster than the block cipher system.

FIG. 1 is a block diagram of a related art stream cipher system.

Referring to FIG. 1, the stream cipher system includes a central processing unit (CPU) 11, a cache 12, a memory controller 13, an encryption/decryption unit 14, an operation unit 15, and an external memory 16.

First, an operation of encrypting data that is transmitted from the CPU 11 to a bus is described. When a request to read/write data is made from the CPU 11, since the data generated is plaintext data that is not encrypted, the data needs to be encrypted in order to be transmitted through the bus. When the CPU 11 requests for reading/writing data, the encryption/decryption unit 14 detects the request. Here, a key stream generation unit 141 included in the encryption/decryption unit 14 synchronizes with a clock signal (that is, from a rising edge and/or a falling edge of a clock signal) and generates a key stream that corresponds to a size of data. Here, the size of data can be expressed, for example, a word count in which lines, words, the number of letters are calculated from bytes or input data. In the operation unit 15, an XOR operation is performed on the key stream and data that are synchronized with each other to be one-to-one mapped in a byte unit, respectively, so as to encrypt the data. As such, encrypted data can be transmitted to the outside through a bus.

Next, an operation of decrypting data that has been encrypted and transmitted through a bus, in order for the CPU 11 to recognize the data will be described. The encrypted data that is transmitted through the bus from the external memory 16 is transmitted to the CPU 11 through the memory controller 13 and the cache 12. However, the CPU 11 cannot recognize encrypted data and thus a decryption process is needed. When encrypted data is transmitted from the external memory 16 through the bus, the encryption/decryption unit 14 detects the transmission. Here, the key stream generation unit 141 included in the encryption/decryption unit 14 synchronizes with a clock signal and generates a key stream. In the operation unit 15, an XOR operation is performed on the key stream and the encrypted data that are synchronized with each other to be one-to-one mapped in a byte unit, respectively, so as to decrypt the encrypted data. The decrypted data is input to the CPU 11.

Here, the area including the CPU 11, the cache 12, the memory controller 13, the encryption/decryption unit 14, and the operation unit 15 may be referred to as a trusted area, and all modules except for the trusted area, that is, the external memory 16, may be referred to as a non-trusted area. Data transmitted through a bus in the non-trusted area can be exposed to the outside by tapping. Here, tapping indicates that data transmitted through a bus is exposed to the outside through other lines. Since a system on chip (SoC) or an inside part of a single chip is referred to as the trusted area, data can be protected. However, when different modules are attached on one board, it is difficult to protect data transmitted between the different modules, since data transmitted through a bus on a board may be exposed by tapping.

### SUMMARY OF THE INVENTION

The present invention provides a method of encrypting data by which data can be safely transmitted to each of a plurality of different modules connected by a bus.

The present invention also provides a method of decrypting data by which data can be safely transmitted to each of a plurality of different modules connected by a bus.

The present invention also provides a bus system through which data can be safely transmitted to each of a plurality of different modules connected by a bus and decline of performance while transmitting encrypted or decrypted data is reduced.

According to an aspect of the present invention, there is provided a method of encrypting data, including: (a) performing an operation on data that is to be transmitted through a bus with a key stream generated from a predetermined key so as to encrypt the data; (b) transmitting the encrypted data to a predetermined module through the bus; and (c) transmitting a synchronization signal that is logic high when the encrypted data is transmitted through the bus to the predetermined module.

The method of encrypting data may further include performing an exclusive OR (XOR) operation on the data and the key stream so as to encrypt the data.

The method of encrypting data may further include generating the key stream based on a seed comprising the predetermined key and additional information, wherein the seed is commonly applied during decrypting the encrypted data in a module that receives the encrypted data.

The method of encrypting data may further include generating the key stream to be synchronized with a clock signal of the bus.

The method of encrypting data may further include synchronizing the synchronization signal with a clock signal of the bus.

The method of encrypting data may further include broadcasting the synchronization signal to at least two predetermined modules.

The method of encrypting data may further include transmitting the synchronization signal through each of a plurality of dedicated wires of at least two predetermined modules.

The method of encrypting data may further include transmitting the synchronization signal to a bus by a control of a controller of the bus.

The method of encrypting data may further include transmitting the synchronization signal to at least one group of a plurality of groups, wherein the plurality of groups comprise at least two predetermined modules.

According to another aspect of the present invention, there is provided computer readable recording medium having embodied thereon a computer program for executing the method of encrypting data, including: (a) performing an operation on data that is to be transmitted through a bus with a key stream generated from a predetermined key so as to encrypt the data; (b) transmitting the encrypted data to a predetermined module through the bus; and (c) transmitting a synchronization signal that is logic high when the encrypted data is transmitted through the bus to the predetermined module.

According to another aspect of the present invention, there is provided a method of decrypting data, including: (a) receiving encrypted data from a predetermined module through a bus; (b) receiving a synchronization signal that is logic high when the encrypted data is transmitted through the bus; and (c) performing an operation on the encrypted data with a key stream generated from a predetermined key when the synchronization signal is logic high.

The method of decrypting data may further include synchronizing the synchronization signal with a clock signal of the bus.

The method of decrypting data may further include performing an exclusive OR (XOR) operation on the encrypted data and the key stream so as to decrypt the encrypted data.

According to another aspect of the present invention, there is provided a computer readable recording medium having embodied thereon a computer program for executing the method of decrypting data, including: (a) receiving encrypted data from a predetermined module through a bus; (b) receiving a synchronization signal that is logic high when the encrypted data is transmitted through the bus; and (c) performing an operation on the encrypted data with a key stream generated from a predetermined key when the synchronization signal is logic high.

According to another aspect of the present invention, there is provided a bus system including at least two modules connected to a bus, wherein each of the modules comprises a module core and a wrapper to interface the module core and the bus, the wrapper encrypts a first data signal generated from the module core to transmit the first encrypted data signal through the bus and outputs a first synchronization signal that is logic high when the first encrypted data signal is transmitted through the bus, and the wrapper also decrypts a second data signal received from the bus according to a second synchronization signal that is logic high when the second data signal is transmitted through the bus and provides the decrypted second data signal to the module core.

The wrapper may include a stream cipher transmitter which generates a key stream from a predetermined key when the first data signal is generated from the module core; and a stream cipher receiver which generates the key stream according to the second synchronization signal when the second data signal is received from the bus.

The key stream may be generated from a seed comprising the predetermined key and additional information and the seed may be commonly applied to each of the modules.

The wrapper may further include a first operation unit which performs an exclusive OR (XOR) operation on the key stream and the first data signal so as to generate the first encrypted data signal; and a second operation unit which performs an XOR operation on the key stream and the second data signal so as to generate the decrypted second data signal.

The system may further include the first and second synchronization signals being transmitted through each of a plurality of dedicated wires of the modules.

### BRIEF DESCRIPTION OF THE DRAWINGS

The above and other features of the present invention will become more apparent by describing in detail exemplary embodiments thereof with reference to the attached drawings in which:

FIG. 1 is a block diagram of a related art stream cipher system;

FIG. 2 is a block diagram of a bus system in a 1:1 configuration according to an exemplary embodiment of the present invention;

FIG. 3 is a block diagram for illustrating in detail a data transmission operation in a bus system, according to an exemplary embodiment of the present invention;

FIG. 4 is a block diagram schematically illustrating a wrapper included in a bus system, according to an exemplary embodiment of the present invention;

FIG. 5 is a block diagram of a bus system in an N: N configuration according to an exemplary embodiment of the present invention;

FIG. 6 is a block diagram for illustrating in detail methods of encrypting and decrypting data in a bus system according to an exemplary embodiment of the present invention;

FIG. 7 is a flowchart illustrating a method of encrypting data, according to an exemplary embodiment of the present invention; and

FIG. 8 is a flowchart illustrating a method of decrypting data, according to an exemplary embodiment of the present invention.

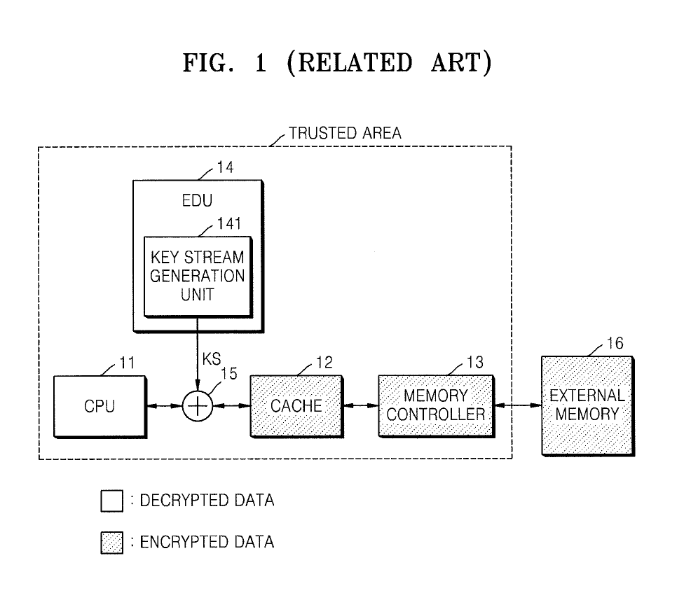

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown. The invention may, however, be embodied in many different forms and should not be construed as being limited to the exemplary embodiments set forth herein; rather, these embodiments are provided so that this disclosure will be thorough and complete, and will fully convey the concept of the invention to those skilled in the art. In the drawings, like reference numerals denote like elements, and the sizes and thicknesses of layers and regions are exaggerated for clarity. Also, the terms used herein are defined according to the functions of the present invention. Thus, the terms may vary depending on users or operators and usages. That is, the terms used herein must be understood based on the descriptions made herein.

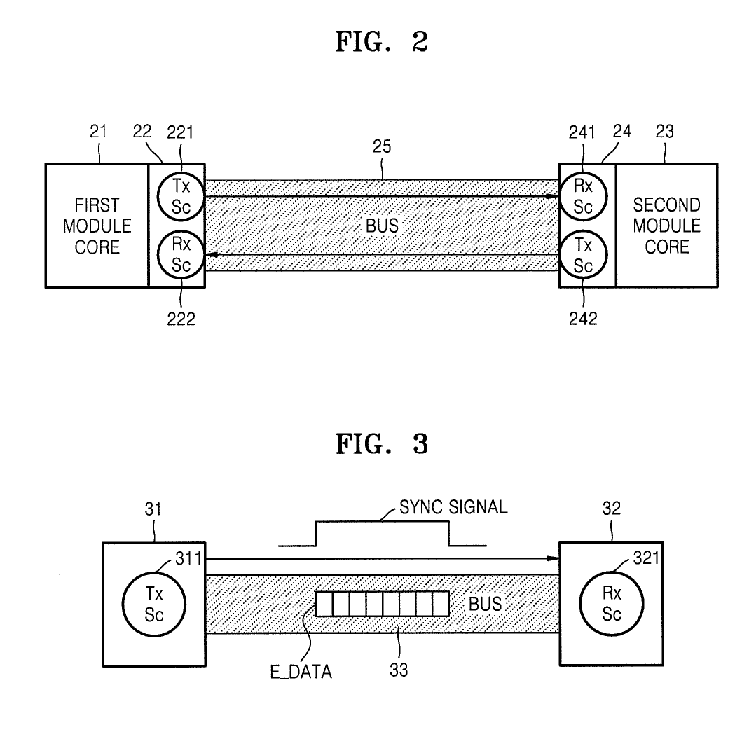

FIG. 2 is a block diagram of a bus system in a 1:1 configuration according to an embodiment of the present invention.

Referring to FIG. 2, the bus system in a 1:1 configuration according to an exemplary embodiment of the present invention includes a first module core 21, a first wrapper 22, a second module core 23, a second wrapper 24, and a bus 25. The first module core 21 and the second module core 23 may be each independently one of a central processing unit (CPU), a peripheral component interconnect (PCI), and a universal asynchronous receiver/transmitter (UART).

The first wrapper 22 converts an output signal of the first module core 21 according to a transmission specification of the bus 25 and monitors a control signal and a data signal received from the bus 25, thereby interfacing the first module core 21 and the bus 25. Also, the first wrapper 22 includes a first stream cipher transmitter (Tx Sc) 221 and a first stream cipher receiver (Rx Sc) 222.

The second wrapper 24 converts an output signal of the second module core 23 according to a transmission specification of the bus 25 and monitors a control signal and a data signal received from the bus 25, thereby interfacing the second module core 23 and the bus 25. Also, the second wrapper 24 includes a second stream cipher receiver (Rx Sc) 241 and a second stream cipher transmitter (Tx Sc) 242.

The first and second stream cipher transmitters 221 and 242 encrypt data that is to be transmitted via the bus 25. More specifically, the first and second stream cipher transmitters 221 and 242 generate a key stream from a seed including a predetermined key and additional information (for example, an initialization vector) and perform an operation on the generated key stream and the data to be transmitted via the bus 25, thereby encrypting the data. For example, the first and second stream cipher transmitters 221 and 242 may perform an XOR operation on the generated key stream and the data to be transmitted through the bus 25, thereby encrypting the data.

The first and second stream cipher receivers 222 and 241 decrypt encrypted data received from the bus 25. More specifically, the first and second stream cipher receivers 222 and 241 generate a key stream from a seed including a predetermined key and additional information and perform an operation on the generated key stream and the encrypted data received from the bus 25, thereby decrypting the data. For example, the first and second stream cipher receivers 222 and 241 may perform an XOR operation on the generated key stream and the encrypted data received from the bus 25, thereby decrypting the data.

In this case, the first and second stream cipher transmitters 221 and 242 and the first and second stream cipher receivers 222 and 241 may have a common seed. More specifically, when the power supply is turned on, the same seed can be provided to the first and second stream cipher transmitters and receivers 221, 222, 241, and 242. Accordingly, the first and second stream cipher transmitters and receivers 221, 222, 241, and 242 can generate the same key streams. However, the order of the key stream used by a synchronization signal of each of a pair of the first stream cipher transmitter 221 and the second stream cipher receiver 241 and a pair of the second stream cipher transmitter 242 and the first stream cipher receiver 222 can be changed. The synchronization signal will be described with reference to FIG. 3.

Each of the first and second stream cipher transmitters 221 and 242 and the first and second stream cipher receivers 222 and 241 may use a Route Coloniale 4 (RC4). The RC4 is an encryption algorithm in a stream form which varies a length of a key through a byte operation and supports an encryption speed that is very fast compared with a block encryption algorithm. However, this is only one exemplary embodiment of the present invention and it is obvious to one of ordinary skill in the art that the first and second stream cipher transmitters 221 and 242 and first and second stream cipher receivers 222 and 241 may use other algorithms.

FIG. 3 is a block diagram for illustrating in detail a data transmission operation in a bus system, according to an exemplary embodiment of the present invention.

Referring to FIG. 3, the bus system in a 1:1 configuration according to an exemplary embodiment of the present invention includes a first module wrapper 31, a second module wrapper 32 and a bus 33. The first module wrapper 31 includes a stream cipher transmitter (Tx Sc) 311 and the second module wrapper 32 includes a stream cipher receiver (Rx Sc) 321.

When data is input, the first module wrapper 31 encrypts the data in the stream cipher transmitter 311 to encrypted data E_DATA and transmits the encrypted data E_DATA to the second module wrapper 32 through the bus 33. When the encrypted data E_DATA is received by the second module wrapper 32, the second module wrapper 32 decrypts the encrypted data E_DATA in the stream cipher receiver 321 and provides the decrypted data to a module (not illustrated) connected to the second module wrapper 32.

In this case, when the encrypted data E_DATA is transmitted through the bus 33, the first module wrapper 31 generates a synchronization signal Sync Signal synchronized with a clock signal (not shown) of the bus 33. The synchronization signal Sync Signal is switched between logic high and logic low according to the encrypted data E_DATA. For example, only when the encrypted data E_DATA is provided to the bus, the synchronization signal may be switched to logic ‘high’ and when the encrypted data E_DATA is not provided to the bus, the synchronization signal may be switched to logic ‘low’.

The synchronization signal Sync Signal generated from the first module wrapper 31 is provided to the stream cipher receiver 321 included in the second module wrapper 32. In an exemplary embodiment of the present invention, the synchronization signal can be provided to the second module wrapper 32 through a dedicated line. Since the signal transmitted through the bus 33 should comply with a bus specification, the synchronization signal is transmitted through a separate dedicated wire (not shown), instead of the bus 33 and thus the bus specification does not need to be changed, thereby improving compatibility. In another exemplary embodiment of the present invention, the synchronization signal may be controlled by a bus controller to be transmitted through the bus 33. Also, in another exemplary embodiment of the present invention, the first module wrapper 31 may be synchronized with the second module wrapper 32 by using control signals of the bus 33, instead of generating a synchronization signal. However, in this case, it may be complicated to be embodied in such a configuration.

The stream cipher receiver 321 included in the second module wrapper 32 receives the encrypted data E_DATA from the bus 33 and the synchronization signal generated from the first module wrapper 31 at the same time. The stream cipher receiver 321 generates a key stream according to the synchronization signal and performs an operation on the encrypted data E_DATA and the key stream, thereby decrypting the data.

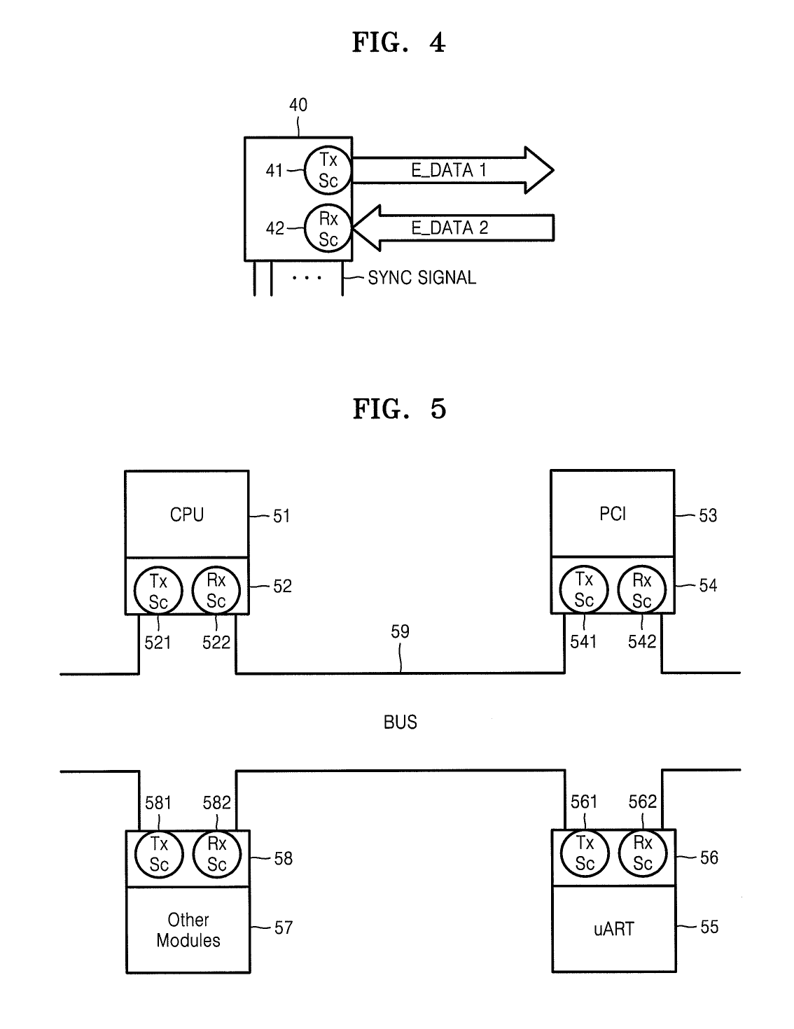

FIG. 4 is a block diagram schematically illustrating an example of a wrapper included in a bus system, according to an exemplary embodiment of the present invention.

Referring to FIG. 4, a wrapper 40 includes a stream cipher transmitter Tx Sc 41 and a stream cipher receiver (Rx Sc) 42. The stream cipher transmitter Tx Sc 41 encrypts a first data signal into a first encrypted data signal E_DATA1 and provides the first encrypted data signal E_DATA1 to a bus. The stream cipher receiver 42 decrypts a second encrypted data signal E_DATA2 received from the bus.

The wrapper 40 transmits a first synchronization signal that is switched between logic high and logic low according to the first encrypted data signal E_DATA1 to another module through a separate dedicated wire, instead of the bus. Also, the wrapper 40 receives a second synchronization signal that is switched between logic high and logic low according to the second encrypted data signal E_DATA2 from another module through a separate dedicated wire, instead of the bus. In other words, the wrapper 40 may have two separate dedicated wires, in addition to the bus. When each of a plurality of different modules is connected in a 1:1 configuration, the wrapper 40 may have two dedicated wires and when each different module is connected in a 1: N configuration, the wrapper 40 may have 2N dedicated wires. Here, N is a natural number greater than 1.

FIG. 5 is a block diagram of a bus system in an N: N configuration according to an exemplary embodiment of the present invention.

Referring to FIG. 5, the bus system in an N: N configuration according to an exemplary embodiment of the present invention includes a CPU 51, a PCI 53, a UART 55, and a bus 59. Also, the bus system in an N: N configuration may further include other modules 57. Here, the CPU 51, the PCI 53, and the UART 55 are only examples of modules connected to the bus 59 and can be other modules or any modules to be developed in the future.

The CPU 51 is the core device of a computer system and controls processes such as interpreting commands, operating data, and comparing and further includes a CPU wrapper 52 in order to interface with the bus 59. The CPU wrapper 52 may include a first stream cipher transmitter 521 and a first stream cipher receiver 522.

The PCI 53 is an interconnection system in devices inserted in expansion slots that are placed near to a microprocessor for high speed operations and further includes a PCI wrapper 54 in order to interface with the bus 59. The PCI wrapper 54 may include a second stream cipher transmitter 541 and a second stream cipher receiver 542.

The UART 55 is a module processing asynchronous serial communication of a computer, which usually takes the form of a microchip and further includes a UART wrapper 56 in order to interface with the bus 59. The UART wrapper 56 may further include a third stream cipher transmitter 561 and a third stream cipher receiver 562.

The other modules 57 may be modules that are to be developed in the future and further includes a wrapper 58 in order to interface with the bus 59. The wrapper 58 may include a fourth stream cipher transmitter 581 and a fourth stream cipher receiver 582.

Since the bus system in FIG. 5 includes four modules, N is 4 and the bus system of FIG. 5 is in a 4:4 configuration. Here, when each of the stream cipher transmitters and the stream cipher receivers are operated independently, the modules of the bus system may be 4*3 pairs (that is, N*(N−1)) and 2*4*3 (that is, 2*N*(N−1)) stream cipher transmitters/receivers are required so that the configuration of the bus system may be complicated.

However, in an exemplary embodiment of the present invention, the stream cipher transmitters/receivers share a common seed and thus encryption and decryption can be performed only with 2*4 (that is, 2*N) stream cipher transmitters/receivers. As described above, since the seed here includes a predetermined key and additional information (for example, an initialization vector IV), the stream cipher transmitters/receivers generate a key stream based on the seed. That is, the first through fourth stream cipher transmitters 521, 541, 561, and 581 and the first through fourth stream cipher receivers 522, 542, 562, and 582 share a common seed and thus the bus system in an N: N configuration can be simply embodied by using only 8 units.

In this case, one module can broadcast a synchronization signal to all modules. For example, the CPU wrapper 52 can broadcast a synchronization signal in order for the synchronization signal to be transmitted to the PCI wrapper 54, the UART wrapper 56 and the wrapper 58. However, this is only one example of the present invention and a plurality of modules can be divided into at least two groups and then a synchronization signal can be transmitted to at least one group from among at least two groups. For example, since the PCI 53 and the UART 55 are referred to as a first group and the other modules are referred to as a second group, the CPU wrapper 52 can transmit a synchronization signal only to the PCI wrapper 54 and the UART wrapper 56 included in the first group.

In an exemplary embodiment of the present invention, the synchronization signal may be a 1-bit signal. Since the bus system in FIG. 5 includes four modules, 2*4 (that is, 2*N) stream cipher transmitters and receivers exist; however, 4*3 (that is, N*(N−1)) synchronization signals are needed. Thus, in general, overhead bits of 4*3 bits (that is, N*(N−1) bits) are generated.

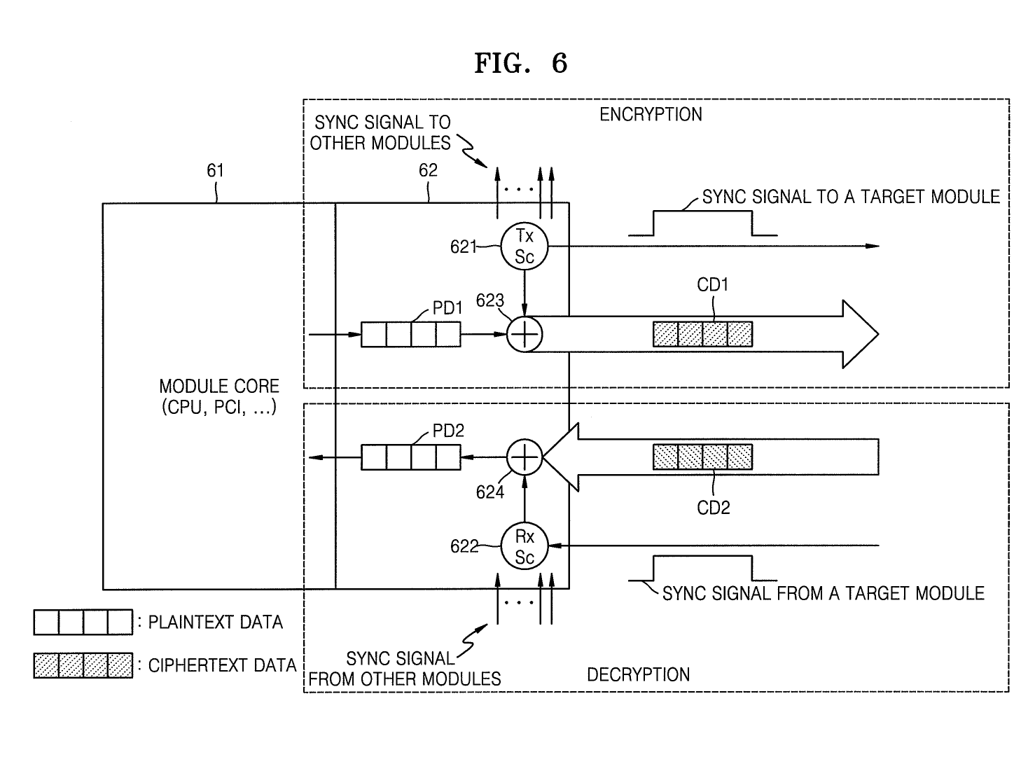

FIG. 6 is a block diagram for illustrating in detail methods of encrypting and decrypting data in a bus system according to exemplary embodiments of the present invention.

Referring to FIG. 6, the bus system according to an exemplary embodiment of the present invention includes a module core 61 and a wrapper 62. The wrapper 62 includes a stream cipher transmitter (Tx Sc) 621 and a stream cipher receiver (Rx Sc) 622. Also, the wrapper 62 may further include first and second operation units 623 and 634.

The module core 61 can be any module such as a CPU or a PCI. The module core 61 can request for reading/writing data and the data that is requested for reading/writing is plain text data PD that is not encrypted. The data generated from the module core 61 should be transmitted to a target module through a bus; however, the data may be exposed to the outside from the bus. Therefore, the plain text data PD is encrypted to be transmitted as ciphertext data CD through the bus.

Hereinafter, an operation of the wrapper 62 will be described by dividing the operation into an encryption operation and a decryption operation.

First, during encryption, the wrapper 62 detects plaintext data PD1 input from the module core 61 and the stream cipher transmitter 621 included in the wrapper 62 generates a key stream to be synchronized with a clock signal of a bus. As described above, the stream cipher transmitter 621 generates a key stream from a seed including a predetermined key and additional information. Here, the generated key stream may be a random number and can be changed in various ways.

The first operation unit 623 included in the wrapper 62 performs an operation on the generated key stream and the plaintext data PD1 to generate encrypted data, that is, ciphertext data CD1. Here, in an exemplary embodiment of the present invention, the first operation unit 623 can perform an XOR operation on the generated key stream and the plaintext data PD1 so as to generate the ciphertext data CD1.

The wrapper 62 simultaneously transmits the ciphertext data CD1 through the bus and generates a synchronization signal that is logic ‘high’ when the ciphertext data CD1 is transmitted through the bus. In other words, the synchronization signal switched between logic high and logic low according to the ciphertext data CD1 and should be synchronized with a clock signal of the bus. Here, when a data frame in the bus is cut off in the middle of the frame due to a delay, the synchronization signal is also switched to logic ‘low’ and when data is transmitted again, the synchronization signal is also switched to logic ‘high’. Accordingly, the key stream that is exactly synchronized with the ciphertext data CD1 received by the stream cipher receiver of the target module can be generated. In another exemplary embodiment, the wrapper 62 can transmit a synchronization signal to other modules. In this case, wrapper 62 can broadcast the synchronization signal or divide the modules into a plurality of groups to transmit the synchronization signal to some of the groups.

Next, during decryption, the wrapper 62 detects encrypted data received from the bus, that is, ciphertext data CD2. In addition, the stream cipher receiver 622 included in the wrapper 62 receives a synchronization signal and generates a key stream according to the synchronization signal. In this case, a seed which is the basis for generating the key stream is the same as the seed of the stream cipher transmitter 621 and stream cipher transmitters/receivers of other modules. The synchronization signal is provided by the modules which generate the ciphertext data CD2 and switches between logic high and logic low according to the ciphertext data CD2. In another exemplary embodiment of the present invention, the wrapper 62 can receive the synchronization signal from other modules.

The stream cipher receiver 622 included in the wrapper 62 performs an operation on the generated key stream and the ciphertext data CD2 and generates decrypted ciphertext data CD2, that is, plaintext data PD2 as a result. Here, in an exemplary embodiment of the present invention, the stream cipher receiver 622 can perform an XOR operation on the generated key stream and the ciphertext data CD2 and generate the plaintext data PD2.

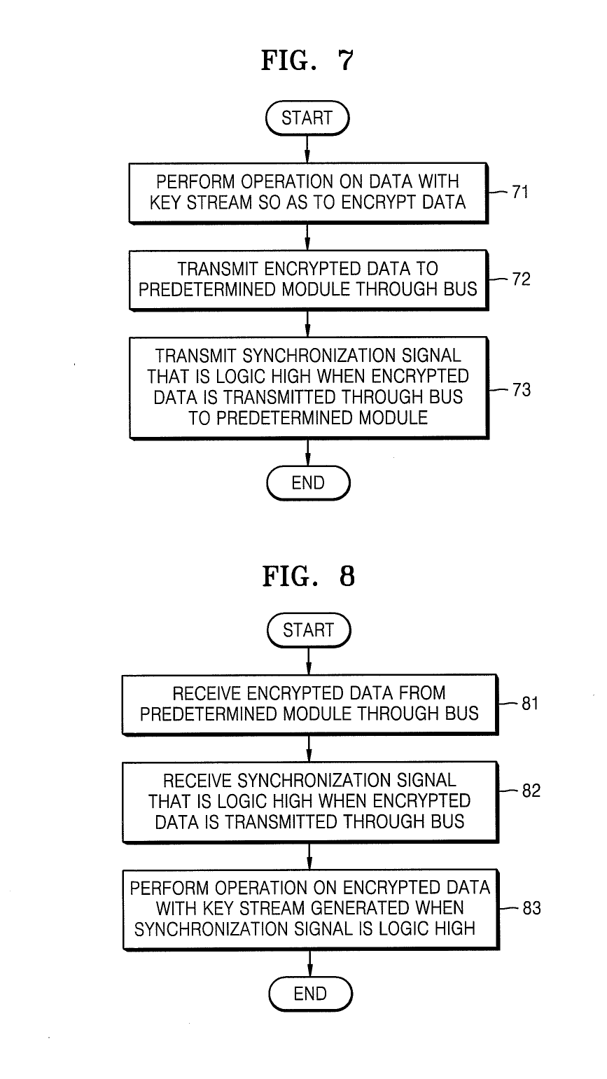

FIG. 7 is a flowchart illustrating a method of encrypting data, according to an exemplary embodiment of the present invention.

Referring to FIG. 7, the method of encrypting data according to an exemplary embodiment of the present invention includes time series operations performed in the bus system of FIG. 6. Therefore, even if any description is omitted below, the description of the bus system in FIG. 6 can be applied to the encryption method according to the exemplary embodiment of the present invention shown in FIG. 7.

Referring to FIG. 7, in operation 71, when data is generated in a module from which the data is transmitted, a wrapper connected to the module performs an operation on the data to be transmitted through a bus with a key stream generated from a predetermined key, thereby encrypting the data. In an exemplary embodiment of the present invention, an XOR operation may be performed on the data to be transmitted through the bus and the key stream so as to encrypt the data. Here, the key stream is generated based on a seed including a predetermined key and additional information and may be synchronized with a clock signal of the bus. Here, the additional information may be represented as an initialization vector.

In operation 72, the wrapper transmits the encrypted data to a predetermined module through the bus. In an exemplary embodiment of the present invention, there may be at least two predetermined modules.

In operation 73, a synchronization signal that is logic high in when the encrypted data is transmitted through the bus is transmitted to the predetermined module. Here, the synchronization signal may be synchronized with the clock signal of the bus. In an exemplary embodiment of the present invention, there may be at least two predetermined modules and the synchronization signal may be broadcasted. Here, the synchronization signal may be transmitted through each dedicated wire of at least two modules or may be transmitted by a control of a controller of a bus. In another exemplary embodiment of the present invention, there may be at least two predetermined modules, the at least two modules can be divided into a plurality of groups, and the synchronization signal can be transmitted to at least one of the of groups.

FIG. 8 is a flowchart illustrating a method of decrypting data, according to an exemplary embodiment of the present invention.

Referring to FIG. 8, the method of decrypting data according to an exemplary embodiment of the present invention includes time series operations performed in the bus system of FIG. 6. Therefore, even if any description is omitted below, the description of the bus system in FIG. 6 can be applied to the decryption method according to the current exemplary embodiment of the present invention shown in FIG. 8.

Referring to FIG. 8, in operation 81, a wrapper connected to a module which receives data receives encrypted data from a predetermined module through a bus.

In operation 82, the wrapper receives a synchronization signal that is logic high when the encrypted data is transmitted through the bus. Here, the synchronization signal may be synchronized with a clock signal of the bus.

In operation 83, the wrapper performs an operation on the encrypted data with a key stream generated from a predetermined key when the synchronization signal is logic high, thereby decrypting the data. In an embodiment of the present invention, an XOR operation may be performed on the key stream and the encrypted data so as to decrypt the encrypted data.

The present invention is not limited to the exemplary embodiments described above and can be suitably modified by one of ordinary skill in the art.

The invention can also be embodied as computer readable codes on a computer readable recording medium. The computer readable recording medium is any data storage device that can store data which can be thereafter read by a computer system. Examples of the computer readable recording medium include read-only-memory (ROM), random-access memory (RAM), CD-ROMs, magnetic tapes, hard disks, floppy disks, flash memory, optical data storage devices, and carrier waves (such as data transmission through the Internet). The computer readable recording medium can also be distributed over network coupled computer systems so that the computer readable code is stored and executed in a distributed fashion.

According to the present invention, an operation is performed on data to be transmitted through a bus with a key stream generated from a predetermined key so as to encrypt the data and the encrypted data is transmitted to a predetermined module through the bus. Also, a synchronization signal that is logic high when the encrypted data is transmitted through the bus is provided to the predetermined module so as to decrypt the data by referring to the synchronization signal. Consequently, security of the data transmitted through the bus can be improved.

In addition, according to the present invention, the synchronization signal is broadcasted and a common seed is shared when the power supply is turned on so that the number of stream cipher transmitters/receivers can be reduced, thereby embodying a simple bus system. Also, even when a new module is attached to the outside of a trusted area, security can be maintained so that the bus system can be easily expanded. Therefore, the methods of encrypting and decrypting data according to the present invention can be efficiently used when at least one separate module is mounted outside of a chip, when various modules are mounted on a board, when an exclusive bus is used, and when in an open bus system.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encrypting data, the method comprising:
(a) performing an operation on data that is to be transmitted through a bus with a key stream generated from a predetermined key so as to encrypt the data;
(b) transmitting the encrypted data to a predetermined module through the bus; and
(c) transmitting a synchronization signal when the encrypted data is transmitted through the bus to the predetermined module.

2. The method of claim 1, wherein an exclusive OR (XOR) operation is performed on the data and the key stream so as to encrypt the data.

3. The method of claim 2, wherein the key stream is generated based on a seed comprising the predetermined key and additional information, wherein the seed is commonly applied during decrypting the encrypted data in a module that receives the encrypted data.

4. The method of claim 2, wherein the key stream is generated to be synchronized with a clock signal of the bus.

5. The method of claim 1, wherein the synchronization signal is synchronized with a clock signal of the bus.

6. The method of claim 5, wherein, in (c), the synchronization signal is broadcasted to at least two predetermined modules.

7. The method of claim 6, wherein, in (c), the synchronization signal is transmitted through each of a plurality of dedicated wires of the at least two predetermined modules.

8. The method of claim 6, wherein, in (c), the synchronization signal is transmitted to the bus by a controller of the bus.

9. The method of claim 5, wherein there are at least two predetermined modules, the at least two predetermined modules are divided into a plurality of groups, and the synchronization signal is transmitted to at least one of the groups.

10. A computer readable recording medium having embodied thereon a computer program for executing the method of encrypting data, the method comprising:
(a) performing an operation on data that is to be transmitted through a bus with a key stream generated from a predetermined key so as to encrypt the data;
(b) transmitting the encrypted data to a predetermined module through the bus; and
(c) transmitting a synchronization signal when the encrypted data is transmitted through the bus to the predetermined module.

11. A method of decrypting data, comprising:
(a) receiving encrypted data from a predetermined module through a bus;
(b) receiving a synchronization signal that is logic high when the encrypted data is transmitted through the bus; and
(c) performing an operation on the encrypted data with a key stream generated from a predetermined key when the synchronization signal is logic high.

12. The method of claim 11, wherein the synchronization signal is synchronized with a clock signal of the bus.

13. The method of claim 11, wherein, in (c), an exclusive OR (XOR) operation is performed on the encrypted data and the key stream so as to decrypt the encrypted data.

14. A computer readable recording medium having embodied thereon a computer program for executing the method of decrypting data, the method comprising:
(a) receiving encrypted data from a predetermined module through a bus;
(b) receiving a synchronization signal that is logic high when the encrypted data is transmitted through the bus; and
(c) performing an operation on the encrypted data with a key stream generated from a predetermined key when the synchronization signal is logic high.

15. A bus system comprising at least two modules connected to a bus, wherein each of the modules comprises a module core and a wrapper to interface the module core and the bus, wherein
the wrapper encrypts a first data signal generated from the module core to transmit the first encrypted data signal through the bus and outputs a first synchronization signal when the first encrypted data signal is transmitted through the bus; and
the wrapper decrypts a second data signal received from the bus according to a second synchronization signal when the second data signal is transmitted through the bus and provides the decrypted second data signal to the module core.

16. The system of claim 15, wherein the wrapper comprises:
a stream cipher transmitter which generates a key stream from a predetermined key when the first data signal is generated from the module core; and
a stream cipher receiver which generates the key stream according to the second synchronization signal when the second data signal is received from the bus.

17. The system of claim 16, wherein the key stream is generated from a seed comprising the predetermined key and additional information and the seed is commonly applied to each of the modules.

18. The system of claim 16, wherein the wrapper further comprises:
a first operation unit which performs an exclusive OR (XOR) operation on the key stream and the first data signal so as to generate the first encrypted data signal;
a second operation unit which performs an XOR operation on the key stream and the second data signal so as to generate the decrypted second data signal.

19. The system of claim 15, wherein the first and second synchronization signals are transmitted through each of a plurality of dedicated wires of the at least two modules.
